(19) United States
(12) Patent Application Publication
(10) Pub. No.: US 2009/0222756 A1
(43) Pub. Date: Sep. 3, 2009

(54) ELECTRONIC DEVICE CAPABLE OF SHOWING PAGE FLIP EFFECT AND METHOD THEREOF

(75) Inventors: XIAO-GUANG LI, Shenzhen City (CN); HSIAO-CHUNG CHOU, Tu-Cheng (TW); KUAN-HONG HSIEH, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/350,231

(22) Filed: Jan. 8, 2009

(30) Foreign Application Priority Data
Feb. 29, 2008 (CN) 200810065462.6

(51) Int. Cl. G06F 3/048

(52) U.S. Cl. 715/776

(57) ABSTRACT

A method for showing page flip effect when use electronic device enjoy electronic documents, including: receiving a flip-page instruction; obtaining an effect page from a storage unit, each effect page include a first part, a second part and a third part, the first part of the effect page is a transparent figure, the second part of the effect page is a flip-page figure which represent the page flip effect, and the third part of the effect page could be a transparent figure or other figures; determining a target page; covering the current page with the effect page and obtaining a part of the target page corresponding the third part of effect page, and covering the third part of the effect page with the part of the target page, then combine a combined page; displaying the combined page. Present invention also provides an electronic device capable of showing page flip effect.

### RELATED APPLICATIONS

This application is related to a co-pending U.S. patent application filed concurrently herewith whose Attorney Docket No is US 18135 and entitled “ELECTRONIC DEVICE CAPABLE OF SHOWING PAGE FLIP EFFECT AND METHOD THEREOF”, which is incorporated herein in its entirety by reference.

### BACKGROUND

1. Technical Field

The disclosure relates to electronic devices and, particularly, to an electronic device capable of showing page flip effect and method thereof.

2. General Background

Nowadays, many electronic devices, e.g., mobile phones, digital photo frames, electronic readers (e-reader), are capable of storing and displaying electronic documents (e.g., digital images, digital texts, etc). Usually, readability of these electronic devices deviates greatly from real paper print. For example, when people flip a page of an electronic document on these electronic devices, the page is directly changed without any visual effect simulating the turning of a page; as a result, it is difficult for people to get the feeling of reading real paper.

In order to resolve this problem, a software capable of generating a page flip effect when flipping through the pages of the digital document is introduced. However, a powerful processing unit is needed to run the software, which results in increase of the cost of these electronic devices.

Therefore, it is necessary to provide an electronic device and a method to overcome the above-identified deficiencies.

### BRIEF DESCRIPTION OF THE DRAWINGS

The components in the drawings are not necessarily drawn to scale, the emphasis instead being placed upon clearly illustrating the principles of the electronic device. Moreover, in the drawings, like reference numerals designate corresponding parts throughout the several views.

FIG. 1 is a block diagram of an electronic device capable of showing information with a page flip effect in accordance with an exemplary embodiment.

FIG. 2 is a schematic diagram illustrating a page fillip effect in accordance with an exemplary embodiment.

FIGS. 3a-3f are a series of schematic diagrams illustrating a full processing of flipping a page in accordance with an exemplary embodiment.

FIG. 4 is a block diagram of an electronic device capable of showing information in a page flip effect in accordance with another exemplary embodiment.

FIG. 5 is a flowchart illustrating a method for showing information in a page flip effect applied in the electronic device of FIG. 1 or FIG. 4 in accordance with an exemplary embodiment.

### DETAILED DESCRIPTION OF THE EMBODIMENTS

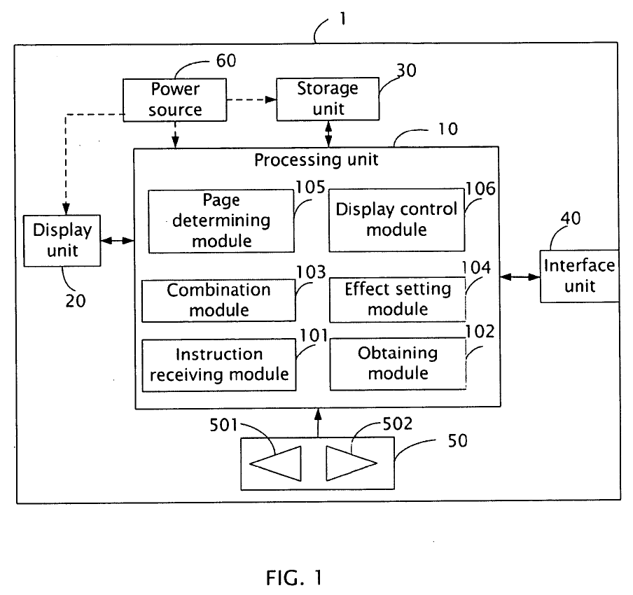

Referring to FIG. 1, an electronic device 1, capable of showing information with a page flip effect in accordance with an exemplary embodiment, includes a processing unit 10, a display unit 20, a storage unit 30, an interface unit 40, an input unit 50, and a power source 60. The electronic device 1 can be an e-reader, a mobile phone, or a digital photo frame, etc.

The interface unit 40 is configured to connect to an external electronic device (not shown). The external device can be a storage card (for example, a secure digital (SD) card, a compact flash (CF) card) or another electronic device (for example, a digital camera, a mobile phone, or a computer).

The input unit 50 is configured to generate instructions in response to user operations. The input unit 50 can be an input key (button), a knob, and the like. In the exemplary embodiment, the input unit 50 is a keyboard that includes a page up key 501, a page down key 502, and other function keys (not shown). The page up key 501 is configured to produce a page up instruction and the page down key 502 is configured to produce a page down instruction. The power source 60 is configured to provide power to elements of the electronic device 1, such as the processing unit 10 and the display unit 20.

The storage unit 30 is configured to store electronic documents. The display unit 20 is configured to display the electronic documents. The electronic documents may include, but are not limited to, audio files, videos, digital images, texts, etc. In the exemplary embodiment, the storage unit 30 is a built-in storage unit, such as a flash memory, a micro drive, and so on. The storage unit 30 also stores a plurality of effect pages of a full page flipping process.

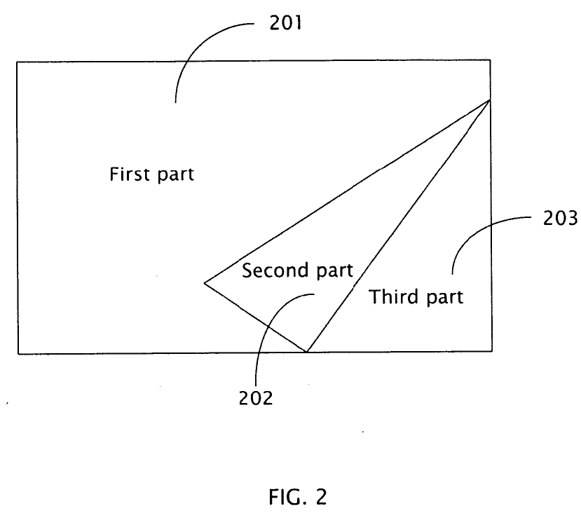

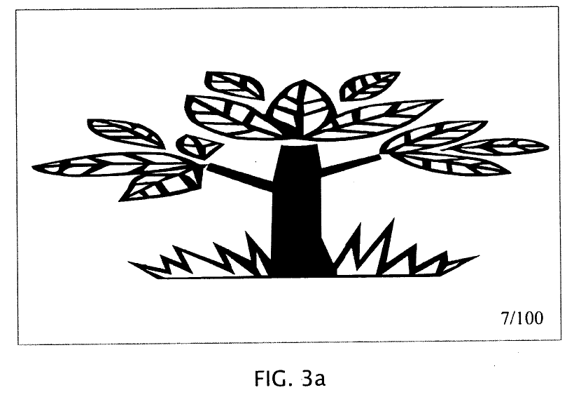

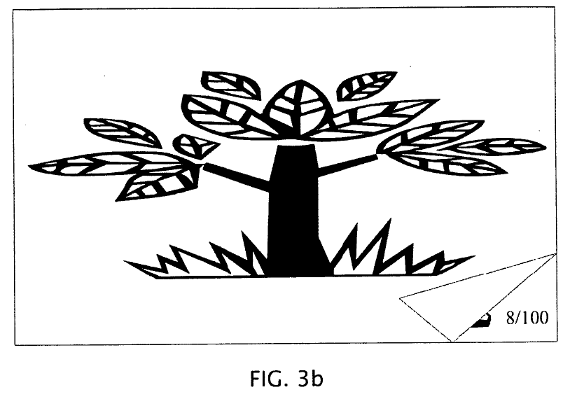

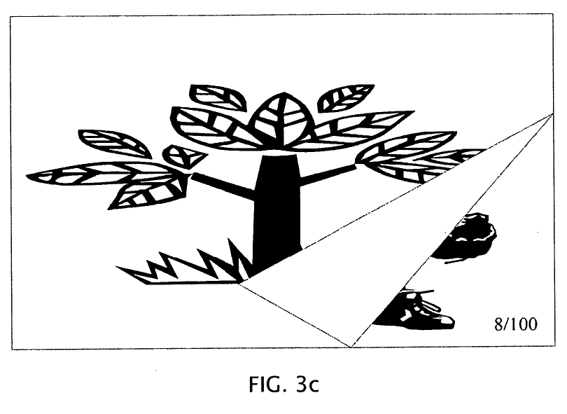

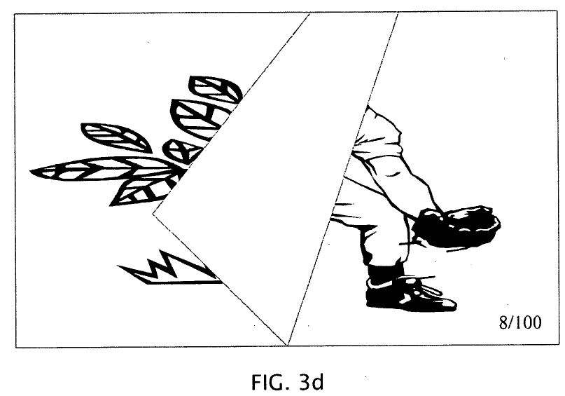

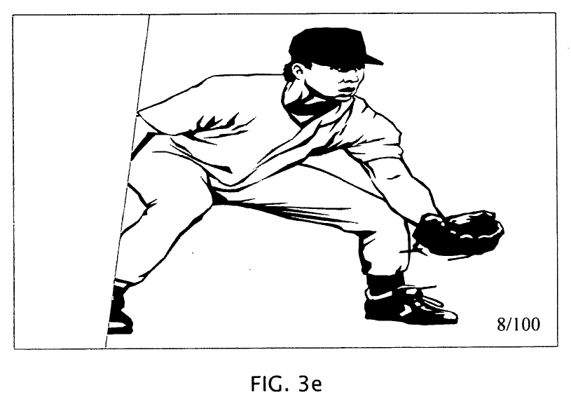

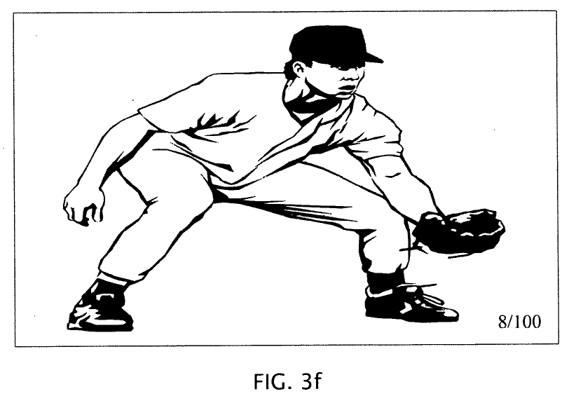

Referring also to FIG. 2, each of the effect pages includes a first part 201, a second part 202, and a third part 203. The first part 201 is a transparent figure. The second part 202 is a flip-page figure representing the flip effect, such as a dog-ear when flipping a page. The dog-ear can be a triangle, a quadrangle, and a pentagon, etc. The third part 203 can be a transparent figure or other figures. The three parts of each of the effect pages are different. Those effect pages are pre-numbered in the full page flipping processing. A series of effect pages combines with a current page and a target page to form a series of combined pages in sequence as shown in FIGS. 3a-3f. FIG. 3a shows a current image without page flipping effect. Then, a first effect page combines with the current page and the target page to form a first combined page is shown in FIG. 3b, a second effect page combine with the current page and the target page to form a second combined page is shown in FIG. 3c. The process goes on as illustrated in FIGS. 3d-3f until all of the effect pages have been processed. The series of combined pages exhibit the page flip effect as if flipping a physical page from the current page to the next page.

The processing unit 10 includes an instruction receiving module 101, an obtaining module 102, a combination module 103, an effect setting module 104, a page determining module 105, and a display control module 106. Functions of the above modules will be described in combination with FIGS. 3a-3f below.

Referring again to FIGS. 3a-3f, when a user views a electronic documents (e.g., a digital text file, or a digital image) through the electronic device 1, the user may input a flip-page instruction through the input unit 50. The instruction receiving module 101 is configured to receive the flip-page instruction generated by the page up key 501 or the page down key 502. The page determining module 105 is configured to determine the target page according to the flip-page instruction. For example, if the flip-page instruction is generated by the page up key 501, the page determining module 105 determines that the target page is the previous page; if the flip-page instruction is generated by the page down key 502, the page determining module 105 determines that the target page is the next page.

For example, if the current page displayed on the display unit 20 is page 7/100 as shown in FIG. 3a, wherein 100 represents a total page number of a current text/album and 7 represents the current page. Therefore, if the flip-page instruction is generated by the page down key 502, the page determining module 105 determines the target page is page 8. The obtaining module 102 obtains the first effect page of those effect pages from the storage unit 30. The combination module 103 covers the current page (i.e., page 7) with the first effect page, obtains a part of the target page (i.e., page 8) whose size and location is the same as that of the third part of the first effect page through a predetermined obtaining manner, and covers the third part of the first effect page with the obtained part of page 8, and thus to obtain the first combined page as shown in FIG. 3b.

With the predetermined obtaining manner, in the exemplary embodiment, the combination module 103 determines a part of the target page whose size and location is the same as that of the third part of the first effect page, and copies the part from the target page (i.e., page 8) to cover the third part of the first effect page.

The display control module 106 controls the display unit 20 to display the first combined page after it has been combined by the combination module 103. Because a part of the first combined page corresponding to the first part of the first effect page is a part of the current page (i.e., page 7), a part of the first combined page corresponding to the second part of the first effect page is the dog-ear, and a part of the first combined page corresponding to the third part of the first effect page is a part of the next page (i.e., page 8), then, the first combined page shows the flipping effect that the page 7 is turned over a corner of page.

After combining and displaying the first combined page, the obtaining module 102, the combination module 103, and the display control module 106 repeats obtaining, covering, and displaying processes described above at each of the predetermine time intervals, using the second combined page as shown in FIG. 3c, then the third combined page as shown in FIG. 3d, etc, until the target page (i.e., page 8) is fully displayed on the display unit 20 as shown in FIG. 3f. That is, after the display unit 20 displays one combined page, the obtaining module 102 determines whether there is a next effect page to be processed. If yes, the obtaining module 102, the combination module 103, and the display control module 106 repeats the obtaining, covering, and displaying processes described above. If not, the display control module 106 controls the display unit 20 to display the whole next page as shown in FIG. 3f. By using the series of combined pages in sequence as shown in FIGS. 3a-3f, the page flip effect has the appearance of a physical page being turned.

Before the user operates the electronic device 1 to view electronic documents, the user can set flipping effect information through the input unit 50. In detail, the effect setting module 104 sets the flipping effect information in response to setting operations on the input unit 50. The flipping effect information may include, but is not limited to, content of the second part of the effect page, the number of the effect pages to be used in the process of completely flipping a page, and the predetermined time interval of obtaining each effect page and displaying each combined page. The content of the second part of the effect page can be, but not limited to, image, text, and blank.

The number of the effect pages is the number of the effect pages obtained by the obtaining module 102 in the process of completely flipping a page. For example, if the number of the effect pages is set as five, then the obtaining module 102 would obtain five effect pages from the storage unit 30, and the number of the effect pages is equal to the number of the combined pages.

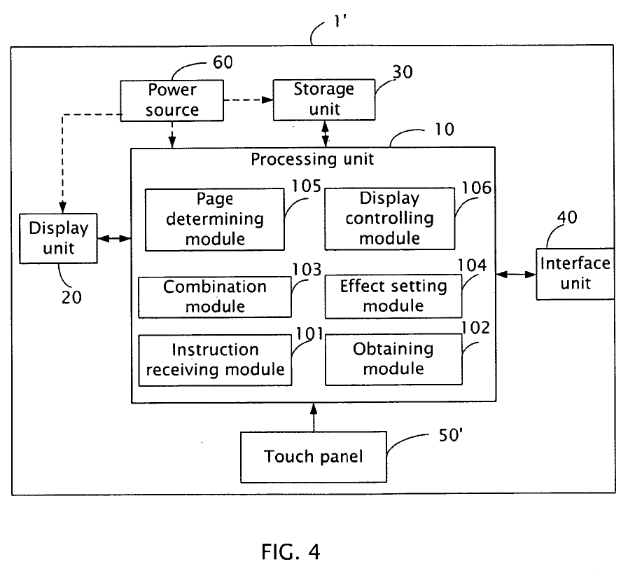

Referring to FIG. 4, the input unit 50′ of an electronic device 1′ in another exemplary embodiment is a touch panel 50′. The touch panel 50′ includes a plurality of touch sensors (not shown), and the touch sensors can be capacitive touch sensors, resistive touch sensors, and the like.

When the user touches the touch panel 50′ to input the flip-page instruction, the page determining module 105 determines the target page according to the movement direction of the user's touch. For example, if the movement direction is from left to right, the page determining module 105 determines the target page is the previous page, otherwise, the page determining module 105 determines the target page is the next page. The movement direction is determined by the page determining module 105 according to a sequence of touch signals produced by the touch sensors.

After the page determining module 105 determines the target page, the obtaining module 102, the combination module 103, and the display control module 106 execute the corresponding function as described in the first exemplary embodiment, then the display control module 106 controls the display unit 20 to display the combined pages predetermined time intervals in sequence, thus obtaining the page flip effect.

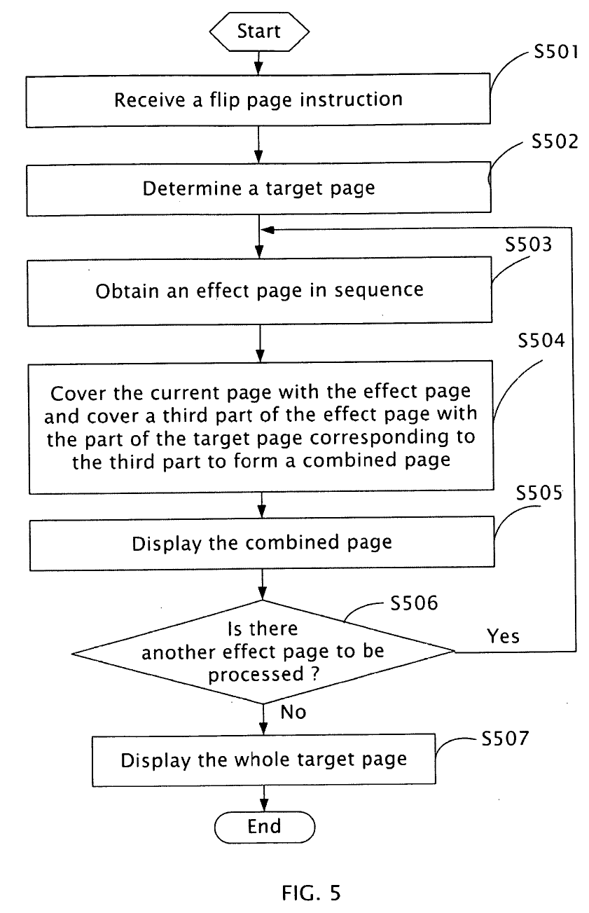

FIG. 5 is a flowchart illustrating a method for showing page flip effect applied in the electronic device 1/1′ in an exemplary embodiment. In step S501, the instruction receiving module 101 receives the flip-page instruction generated by the input unit 50/50′ in response to the user's operations.

In step S502, the page determining module 105 determines the target page according to the flip-page instruction. For example, if the flip-page instruction is the page up instruction, the page determining module 105 determines the target page is the previous page; if the flip-page instruction is the page down instruction, the page determining module 105 determines the target page is the next page.

In step S503, the obtaining module 102 obtains one of the effect pages from the storage unit 30 in sequence. For example, if the previous obtained effect page is a second effect page, the obtaining module 102 obtains a third effect page.

In step S504, the combination module 103 covers the current page with the obtained effect page, and then covers the third part 203 of the obtained effect page with a part of the target page whose size and location is the same as that of the third part of the obtained effect page, thus obtaining the combined page.

In step S505, the display control module 106 controls the display unit 20 to display the combined page.

In step S506, the obtaining module 102 determines whether there is still another effect page to be processed after the display unit 20 displays the combined page thereon.

If there is still another effect page to be processed, the procedure returns to step S503. Otherwise, in step S507, the display control module 106 controls the display unit 20 to display the whole target page when the predetermined time interval elapses.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. An electronic device capable of showing page flip effect, the electronic device comprising:
an input unit configured to generate instructions in response to a user operations;
a storage unit configured to store electronic documents and a plurality of effect pages, wherein each of the effect pages comprises a first part, a second part, and a third part, the first part is a transparent figure, the second part is a flip-page figure representing a flipping effect;
a display unit configured to display the electronic documents;
a processing unit comprising:
an instruction receiving module configured to receive a flip-page instruction produced by the input unit;
a page determining module configured to determine a target page according to the flip-page instruction;
an obtaining module configured to obtain one of the effect pages in sequence when the instruction receiving module receives the flip-page instruction;
a combination module configured to cover a current page with the obtained effect page, and cover the third part of the obtained effect page with a part of the target page whose size and location is the same as that of the third part of the obtained effect page, and produce a combined page;
a display control module configured to control the display unit to display the combined page.

2. The electronic device of claim 1, wherein the obtaining module is further configured for determining whether there is still another effect page to be processed, if there is still another effect page to be processed, the obtaining module, the combination module, and the display control module repeats the obtaining, covering, and displaying processes; if all of the effect pages have been processed, the display control module controls the display unit to display the whole target page.

3. The electronic device of claim 1, wherein the processing unit further comprises an effect setting module configured to set flipping effect information, the flipping effect information comprises content of the second part of the effect page, the number of the effect pages to be used in the process of completely flipping a page, and a predetermined time interval of obtaining one of the effect pages and displaying the combined page.

4. The electronic device of claim 3, wherein the content of the second part of the effect page is selected from the group consisting of image, text, and blank.

5. The electronic device of claim 1, wherein the input unit is a key board which comprises a page up key, a page down key, and other functional keys, the page determining module determines the target page according to the flip-page instruction that is produced by the page up key or the page down key.

6. The electronic device of claim 1, wherein the input unit is a touch panel, the page determining module determines the target page according to a movement direction of touch operations thereon.

7. The electronic device of claim 1, wherein the combination module is capable of determining a part of the target page whose size and location is the same as that of the third part of the effect page, and copying the determined part of the target page and covering the third part of the effect page.

8. The electronic device of claim 1, wherein the electronic device is selected from the group consisting of an e-reader, a mobile phone, and a digital photo frame.

9. A method of an electronic device for showing page flip effect when the electronic device displays a change of electronic documents, the method comprising:
receiving a flip-page instruction produced by an input unit;
determining a target page according to the flip-page instruction;
obtaining one of effect pages in sequence, wherein each of the effect pages comprises a first part, a second part, and a third part, the first part is a transparent figure and the second part is a flip-page figure representing a flipping effect;
covering a current page with the obtained effect page and covering the third part of the obtained effect page with a part of the target page whose size and location is the same as that of the third part of the obtained effect page to obtain a combined page; and
displaying the combined page.

10. The method of claim 9, further comprising:
determining whether there is still another effect page to be processed;
displaying the whole target page if all the effect pages have been processed; or
returning to the step of obtaining one of the effect pages if there is still another effect page to be processed.

11. The method of claim 9, further comprising:
setting flipping effect information, wherein the flip effect information comprises content of the second part of the effect page, the number of the effect pages to be used in the process of completely flipping a page, and a predetermined time interval of obtaining each effect page and displaying each combined page; and
storing the flipping effect information.

12. The method of claim 9, wherein the step of obtaining one of the effect pages which are organized in sequence comprises:
obtaining one of the effect pages according to a previous obtained effect page.

13. The method of claim 9, wherein the step of covering the third part of the obtained effect page with a part of the target page whose size and location is the same as that of the third part of the obtained effect page comprises:
determining a part of the target page whose size and location is the same as that of the third part of the effect page;
copying the determined part of the target page; and
covering the third part of the effect page with the copied part of the target page.
